(19) United States
(12) Patent Application Publication
(10) Pub. No.: US 2023/0047370 A1
(43) Pub. Date: Feb. 16, 2023

(54) COMMUNICATION SYSTEM, RELAY DEVICE, AND METHOD OF COMMUNICATING

(71) Applicant: FUJITSU LIMITED, Kawasaki-shi (JP)

(72) Inventors: Masanori NAGANUMA, Yokohama (JP); Yoshinori Sano, Yokohama (JP); Arata Koide, Shinagawa (JP)

(73) Assignee: FUJITSU LIMITED, Kawasaki-shi (JP)

(21) Appl. No.: 17/745,916

(22) Filed: May 17, 2022

(30) Foreign Application Priority Data
Aug. 11, 2021 (JP) 2021-131161

(51) Int. Cl. H04L 45/00

(52) U.S. Cl. CPC H04L 45/22

(57) ABSTRACT

A communication system includes a first communication device, a second communication device, a third communication device, and a relay device includes a memory, and a processor coupled to the memory and configured to, in a state where a first path through which the second communication device is coupled to the third communication device is established, when a coupling request command for establishing a second path through which the first communication device is coupled to the third communication device is received from the first communication device, establish the second path and cancel the first path in a case where the coupling request command that includes a forced switching instruction is detected.

### CROSS-REFERENCE TO RELATED APPLICATION

This application is based upon and claims the benefit of priority of the prior Japanese Patent Application No. 2021-131161, filed on Aug. 11, 2021, the entire contents of which are incorporated herein by reference.

### FIELD

The embodiments discussed herein are related to a communication system, a relay device, and a method of communicating.

### BACKGROUND

In recent years, communication systems have been developed in which a host device and a relay device are coupled to each other by the Transmission Control Protocol/Internet Protocol (TCP/IP), and the relay device and an input/output (IO) device (printer or the like) are coupled to each other by a fiber channel communication protocol.

With such communication systems, long-distance communication between the host device and the relay device may be enabled by the TCP/IP, and the reliability of communication between the relay device and the IO device may be improved by the fiber channel communication protocol.

As the related art, for example, a technique has been proposed in which a node at one end or a node at another end changes a state of a path when receiving a management command for the path from a user. Also, a technique has been proposed in which, when it is determined that a state in a first communication channel which communicably couples elements of a network becomes unacceptable for continuous use, the communication channel is switched to a second communication channel.

Japanese Laid-open Patent Publication No. 7-143160 and Japanese National Publication of International Patent Application No. 2002-540643 are

### SUMMARY

According to an aspect of the embodiments, a communication system includes a first communication device, a second communication device, a third communication device, and a relay device includes a memory, and a processor coupled to the memory and configured to, in a state where a first path through which the second communication device is coupled to the third communication device is established, when a coupling request command for establishing a second path through which the first communication device is coupled to the third communication device is received from the first communication device, establish the second path and cancel the first path in a case where the coupling request command that includes a forced switching instruction is detected.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an example of a communication system according to a first embodiment;

FIG. 2 is a diagram for explaining an example of the communication system according to the first embodiment;

FIG. 3 is a diagram illustrating an example of a communication system having an optical fiber communication protocol;

FIG. 4 is a diagram illustrating an example of a communication system having a fiber channel communication protocol;

FIG. 5 is a diagram illustrating an example of a communication system according to a second embodiment;

FIG. 6 is a diagram illustrating an example of the hardware configuration of a relay device;

FIG. 7 is a diagram illustrating an example of a basic sequence of path connect control;

FIG. 8 is a diagram illustrating an example of a sequence of the path connect control;

FIG. 9 is a diagram illustrating an example of a sequence of the path connect control;

FIG. 10 is a diagram illustrating an example of a sequence of the path connect control;

FIG. 11 is a diagram illustrating an example of a sequence of the path connect control;

FIG. 12 is a diagram illustrating an example of a sequence of the path connect control;

FIG. 13 is a diagram illustrating an example of a sequence of the path connect control;

FIG. 14 is a diagram illustrating an example of a basic sequence of path disconnect control;

FIG. 15 is a diagram illustrating an example of a sequence of the path disconnect control;

FIG. 16 is a diagram illustrating an example of a sequence of the path disconnect control;

FIG. 17 is a diagram illustrating an example of a sequence of the path disconnect control;

FIG. 18 is a diagram illustrating an example of a sequence of the path disconnect control;

FIG. 19 is a diagram illustrating an example of a sequence of the path disconnect control;

FIG. 20 is a diagram illustrating an example of a sequence of the path disconnect control;

FIG. 21 is a diagram for explaining an example of a path switching control;

FIG. 22 is a diagram illustrating an example of a sequence of the path switching control; and

FIG. 23 is a diagram illustrating an example of an interface correlation between a host device and the relay device.

### DESCRIPTION OF EMBODIMENTS

In a communication system, when a host device accesses an input/output (IO) device to perform communication, a path is established between the host device and the IO device via a relay device. Furthermore, in a case where there is a request to a second path for coupling from a first host device to the IO device in a state where a first path has already been established between a second host device and the IO device via the relay device, the path may be switched from the first path to the second path.

However, when such path switching is executed, there is a possibility of establishment, between the first host device and the relay device, of the second path for the first host device while the first path for the second host device remains established between the relay device and the IO device.

In such a state, the logic of the path established between the first host device and the relay device is not coincident with the logic of the path established between the relay device and the IO device. In this case, for example, there is a possibility that the next and subsequent operations such as path switching are not necessarily correctly executed.

Hereinafter, the embodiments of a technique that allows ensuring of the consistency of the logics of the paths when path switching is executed will be described with reference to the drawings.

### First Embodiment

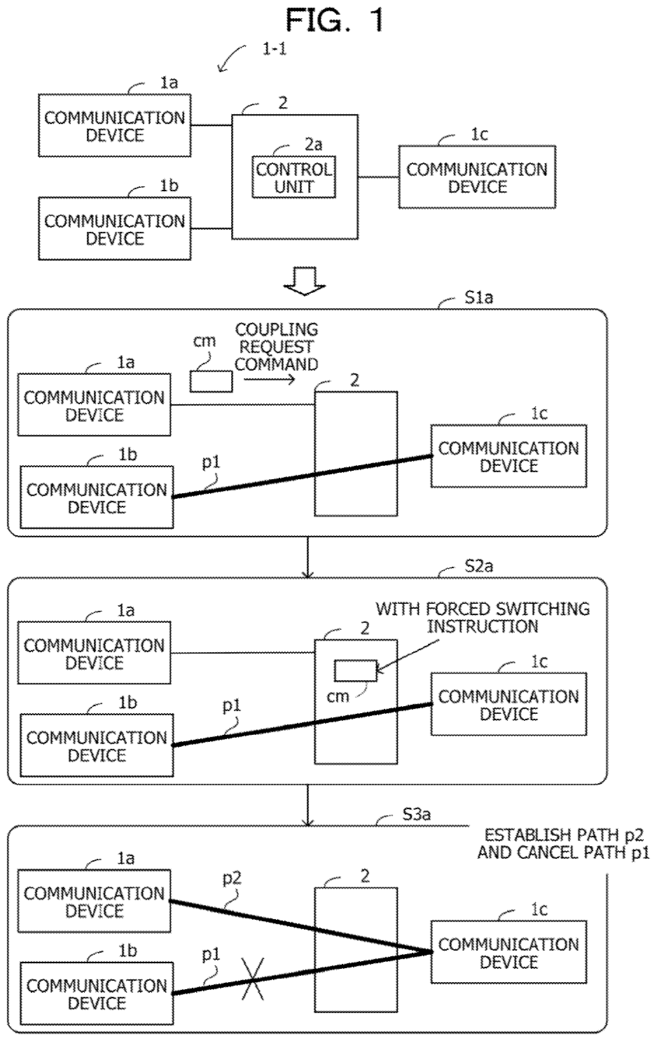

FIG. 1 is a diagram for explaining an example of a communication system according to a first embodiment. A communication system 1-1 includes a communication device 1a (first communication device), a communication device 1b (second communication device), a communication device 1c (third communication device), and a relay device 2. The communication devices 1a, 1b, and 1c are coupled to the relay device 2. For example, the communication devices 1a and 1b correspond to a host device disposed on a mainframe side, and, for example, the communication device 1c corresponds to an IO device that is a peripheral device such as a printer. The relay device 2 includes a control unit 2a. A processor (not illustrated) included in the relay device 2 realizes the function of the control unit 2a by executing a predetermined program.

Operation will be described. It is assumed that a path p1 (first path) that couples the communication device 1b and the communication device 1c to each other via the relay device 2 is established.

[Operation S1a] The control unit 2a receives from the communication device 1a a coupling request command cm for establishing a path from the communication device 1a to the communication device 1c.

[Operation S2a] The control unit 2a determines whether a forced switching instruction included in the coupling request command cm exists.

[Operation S3a] In a case where the forced switching instruction is detected, the control unit 2a establishes, based on the coupling request command cm, a path p2 (second path) coupling the communication device 1a and the communication device 1c to each other via the relay device 2 and, further, cancels the path p1. Thus, path switching from the path p1 to the path p2 is forcibly executed.

As described above, in the communication system 1-1, in a case where the relay device 2 detects the forced switching instruction for the path p2, priority is given to the consistency of the logic of the path p2 for which the forced switching instruction is present over the logic of the already established path p1, thereby the path p1 is canceled and the path p2 is established.

In this way, the path p2 is established between the communication device 1a and the relay device 2, and the path p2 is established between the relay device 2 and the communication device 1c. This may enable the logic of the path between the communication device 1a and the relay device 2 and the logic of the path between the relay device 2 and the communication device 1c to be coincident with each other at all times. Thus, the consistency of the logics of the paths may be ensured when the path switching is executed.

Accordingly, when the path switching is executed, a state where the logics of the paths are not coincident with each other may be avoided. For example, such a state where the path p2 for the communication device 1a is established between the communication device 1a and the relay device 2 while the path p1 for the communication device 1b remains established between the relay device 2 and the communication device is may be avoided.

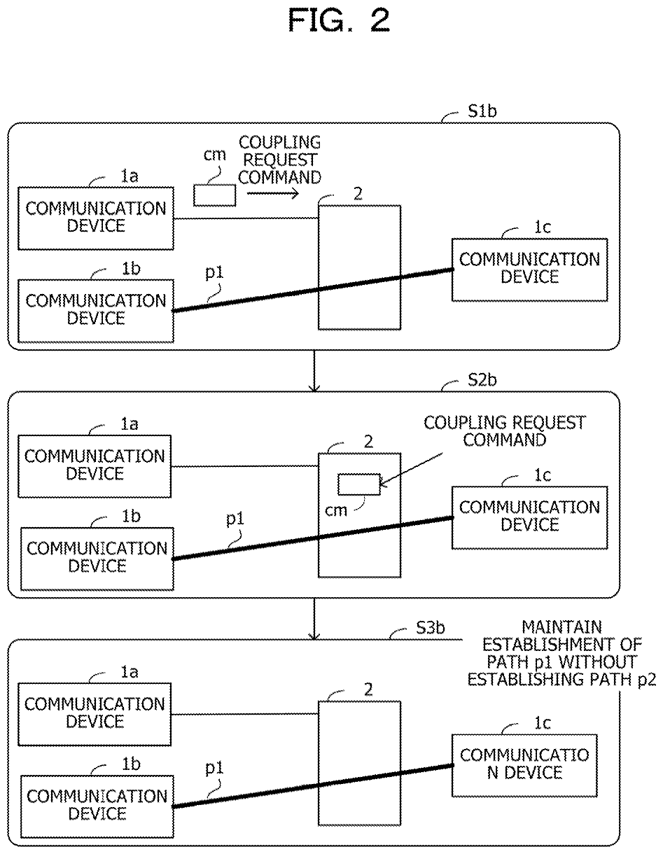

FIG. 2 is a diagram for explaining an example of the communication system according to the first embodiment. It is assumed that the path p1 is established between the communication device 1b and the communication device 1c via the relay device 2.

[Operation S1b] The control unit 2a receives from the communication device 1a the coupling request command cm for establishing a path from the communication device 1a to the communication device 1c.

[Operation S2b] The control unit 2a determines whether the forced switching instruction included in the coupling request command cm is present.

[Operation S3b] In a case where the forced switching instruction is not detected, the control unit 2a rejects the coupling request command cm and maintains the establishment of the path p1 without establishing the path p2.

As described above, in the communication system 1-1, in a case where the relay device 2 does not detect the forced switching instruction for the path p2, priority is given to the consistency of the logic of the already established path p1 over the logic of the path p2 for which the coupling request is issued, thereby the path p1 is maintained.

In this way, a state where the path p1 is established between the communication device 1b and the relay device 2 and the path p1 is established between the relay device 2 and the communication device 1c continues. This may enable the logic of the path between the communication device 1b and the relay device 2 and the logic of the path between the relay device 2 and the communication device 1c to be coincident with each other. Thus, the consistency of the logics of the paths may be ensured.

Accordingly, a state where the logics of the paths are not coincident with each other may be avoided. For example, such a state where the path p2 for the communication device 1a is established between the communication device 1a and the relay device 2 while the path p1 for the communication device 1b remains established between the relay device 2 and the communication device 1c may be avoided.

### Optical Fiber Communication Protocol/Fiber Channel Communication Protocol

Next, a system using an optical fiber communication protocol/a fiber channel communication protocol between the mainframe and peripheral devices will be described.

As protocols for the communication interface between a mainframe and peripheral devices, an optical fiber communication protocol and a fiber channel communication protocol are widely used. The optical fiber communication protocol is, for example, a protocol compatible with the Enterprise System Connection (ESCON), and the fiber channel communication protocol is, for example, a protocol compatible with the Fibre Channel Single Byte 2 (FC-SB-2).

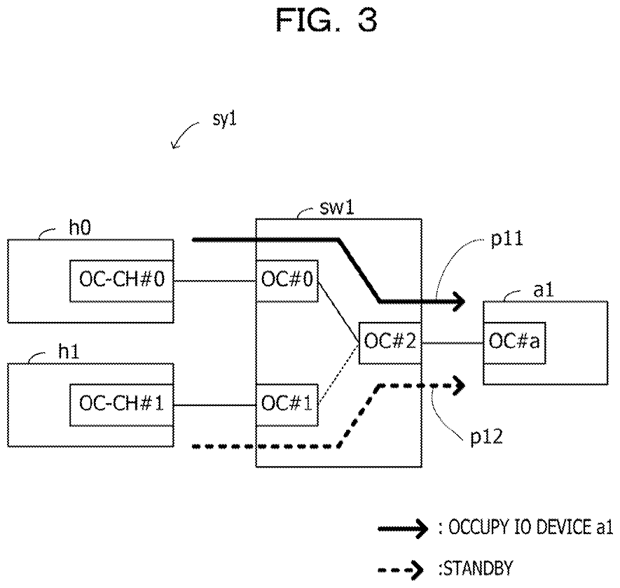

FIG. 3 is a diagram illustrating an example of a communication system having the optical fiber communication protocol. A communication system sy1 includes host devices h0 and h1, a relay device sw1, and an IO device a1. The host devices h0 and h1 and the IO device a1 are coupled to the relay device sw1.

The host devices h0 and h1 are devices disposed on the mainframe side, and the IO device a1 is a peripheral device (for example, it is assumed that the IO device a1 is a printer). The relay device sw1 is a device that performs relay communication by using switching of the optical fiber communication protocol.

The host device h0 includes a communication channel port OC-CH #0, and the host device h1 includes a communication channel port OC-CH #1. The relay device sw1 includes communication ports OC #0, OC #1, and OC #2, and the IO device a1 includes a communication port OC #a.

In a case where a job is executed from the host device h0 to the IO device a1, the relay device sw1 switches the path to couple the communication port OC #0 to the communication port OC #2. The job is transmitted from the communication channel port OC-CH #0 of the host device h0 to the communication port OC #a of the IO device a1 via the communication ports OC #0 and OC #2 of the relay device sw1, the job is executed by the IO device a1, and, for example, data is printed.

In a case where the job is executed simultaneously from the host devices h0 and h1 to the IO device a1, there is a risk that the data transmitted from the host devices h0 and h1 to the IO device a1 is simultaneously printed.

Accordingly, before the job is transmitted from the host device h0 to the IO device a1, a command for occupying the path between the communication ports OC #0 and OC #2 is issued from the host device h0 side to the relay device sw1 so as to inhibit the execution of the job from the host device h1 to the IO device a1. In the example illustrated in FIG. 3, a path p11 is occupied by the host device h0, and a path p12 for the host device h1 is in a standby state.

As described above, the communication system sy1 in which the relay device sw1 that performs switching based on the optical fiber communication protocol is disposed between the host devices h0, h1, and the IO device a1 includes an IO exclusive operation mechanism that occupies one of the paths for communicating with the IO device a1 and causes the other path to be waited and excluded.

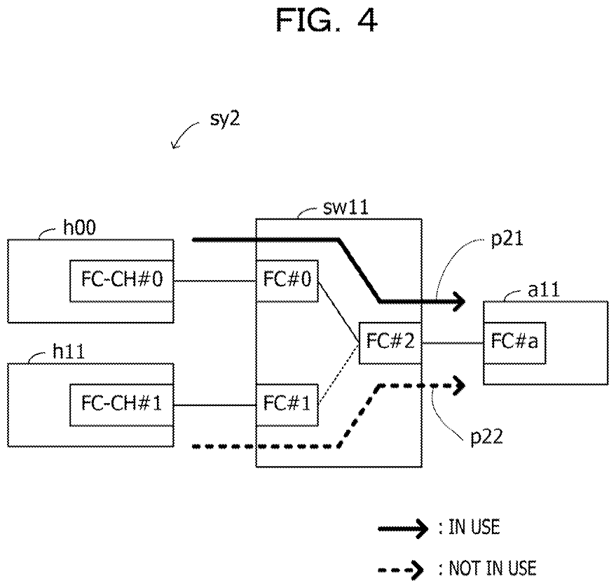

FIG. 4 is a diagram illustrating an example of a communication system having the fiber channel communication protocol. A communication system sy2 includes host devices h00 and h11, a relay device sw11, and an IO device a11. The host devices h00 and h11 and the IO device a11 are coupled to the relay device sw11.

The host devices h00 and h11 are devices disposed on the mainframe side, and the IO device a11 is a peripheral device (for example, a printer). The relay device sw11 is a device that performs relay communication by using switching of the fiber channel communication protocol.

The host device h00 includes a communication channel port FC-CH #0, and the host device h11 includes a communication channel port FC-CH #1. The relay device sw11 includes communication ports FC #0, FC #1, and FC #2, and the IO device a11 includes a communication port FC #a.

In a case where a job is executed from the host device h00 to the IO device a11, the relay device sw11 switches the path to couple the communication port FC #0 to the communication port FC #2. The job is transmitted from the communication channel port FC-CH #0 of the host device h00 to the communication port FC #a of the IO device a11 via the communication ports FC #0 and FC #2 of the relay device sw11, the job is executed by the IO device a11, and data is printed.

As described above, also in the communication system sy2, similarly to the communication system sy1, the relay device sw11 is disposed between the host devices h00, h11 and the IO device a11 to switch the path. However, the relay device sw11 having the fiber channel communication protocol does not include the IO exclusive operation mechanism similar to that of the relay device sw1 which has the optical fiber communication protocol and which is disposed in the communication system sy1.

For example, the communication system sy2 having the fiber channel communication protocol has the function of dynamic path switching between the path p21 and the path p22 but does not have the function of occupying one of the paths for communication with the IO device a11 and causing the other path to wait to be excluded. In a system that does not have such an IO exclusive operation mechanism, the logic of the path between the host devices h00, h11 and the relay device sw11 and the logic of the path between the relay device sw11 and the IO device a11 are not necessarily coincident with each other.

The present disclosure is made in view of the above-described problem and provides an IO exclusive operation mechanism in a system having a fiber channel communication protocol to enable execution of path switching while ensuring consistency of a path logic.

### Second Embodiment

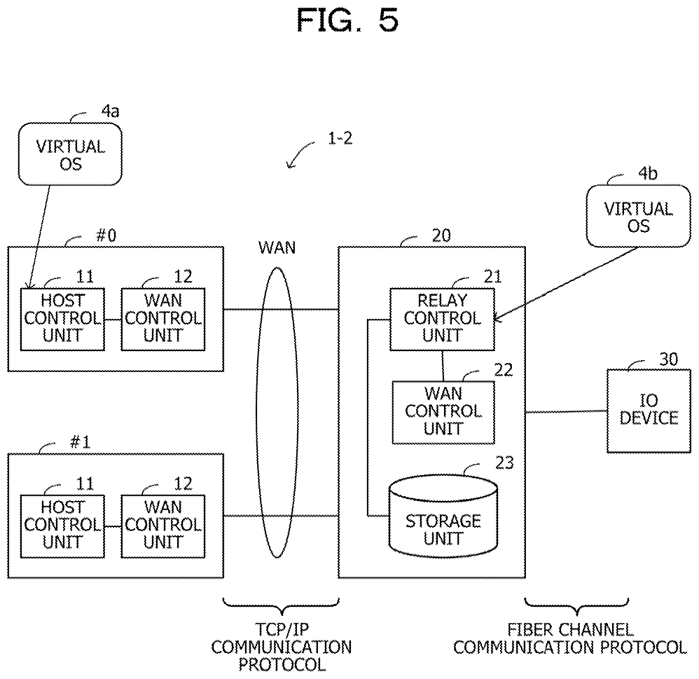

Next, a second embodiment is described below. FIG. 5 is a diagram illustrating an example of a communication system according to the second embodiment. A communication system 1-2 includes host devices #0 and #1, a relay device 20, and an IO device 30. The host devices #0 and #1 and the relay device 20 are coupled to each other by the Transmission Control Protocol/Internet Protocol (TCP/IP) via a wide area network (WAN), and the relay device 20 and the IO device 30 are coupled to each other by the fiber channel communication protocol.

The host devices #0 and #1 each include a host control unit 11 and a WAN control unit 12. The host control unit 11 performs operation control of the host devices #0 and #1, and the WAN control unit 12 performs communication interface control of the WAN.

The relay device 20 includes a relay control unit 21, a WAN control unit 22, and a storage unit 23. The relay control unit 21 has the function of the control unit 2a illustrated in FIG. 1. Based on a coupling request command or a decoupling request command transmitted from the host devices #0 and #1, the relay control unit 21 performs path connect control (path coupling control) and path disconnect control (path decoupling control). The WAN control unit 22 performs communication interface control of the WAN. The WAN control unit 22 may include a communication interface with the IO device 30. The storage unit 23 stores a table structure (a management table to be described later) for managing a coupling state between the host devices #0, #1 and the IO device 30. The storage unit 23 also stores control information and the like related to operation control of the relay device 20. Although the fiber channel communication protocol is used between the relay device 20 and the IO device 30, a communication protocol of Ethernet (registered trademark) may be used.

The above-described host control unit 11 operates in a virtual operating system (OS) 4a, and the above-described relay control unit 21 operates in a virtual OS 4b. For example, when the path switching is executed, the virtual OSs 4a and 4b are transmitted from upper software of the communication system 1-2 (for example, upper software of the host device #0) to upper layers of the host devices #0, #1-and the relay device 20 to be set in the upper layers of the host devices #0, #1-and the relay device 20.

As described above, when the path switching is executed, the virtual OSs 4a and 4b are transmitted to the host devices #0, #1 and the relay device 20, and predetermined functions of the host control unit 11 and the relay control unit 21 are executed. Thus, an operator may set, in detail, the detailed functions executable by the virtual OSs 4a and 4b in the upper layers, and accordingly, the flexibility of a path switching process may be improved.

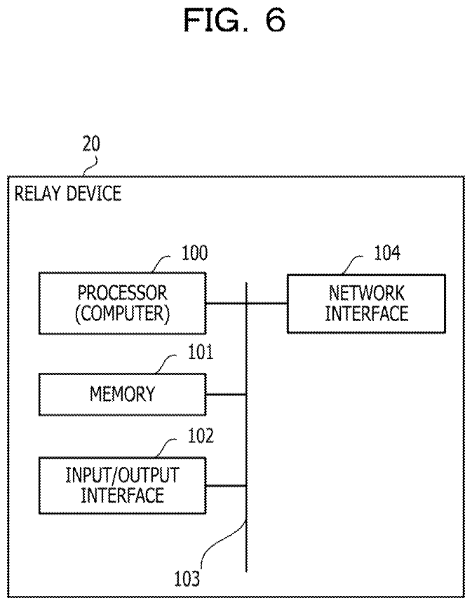

FIG. 6 is a diagram illustrating an example of the hardware configuration of the relay device. A processor (computer) 100 controls the entirety of the relay device 20. The processor 100 realizes the function of the relay control unit 21.

A memory 101, an input/output interface 102, and a network interface 104 are coupled to the processor 100 via a bus 103. The processor 100 may be a multiprocessor. The processor 100 is, for example, a central processing unit (CPU), a microprocessor unit (MPU), a digital signal processor (DSP), an application-specific integrated circuit (ASIC), or a programmable logic device (PLD). The processor 100 may be a combination of two or more elements of a CPU, an MPU, a DSP, an ASIC, and a PLD.

The memory 101 realizes the function of the storage unit 23 and is used as a main storage device of the relay device 20. At least part of OS programs and at least part of application programs to be executed by the processor 100 are temporarily stored in the memory 101. The memory 101 also stores various types of data used in processing by the processor 100.

The memory 101 is also used as an auxiliary storage device of the relay device 20 and stores the OS programs, the application programs, and various types of data. The memory 101 may include, as the auxiliary storage device, a semiconductor storage device such as a flash memory or a solid-state drive (SSD) and a magnetic recording medium such as a hard disk drive (HDD).

Examples of the peripheral device coupled to the bus 103 include the input/output interface 102 and the network interface 104. The input/output interface 102 may be coupled to an information input device such as a keyboard and a mouse. The input/output interface 102 transmits a signal transmitted from the information input device to the processor 100.

Furthermore, the input/output interface 102 also functions as a communication interface for allowing the peripheral device to be coupled thereto. For example, an optical drive device that uses laser light or the like to read data recorded on an optical disk may be coupled to the input/output interface 102. Examples of the optical disk include a Blu-ray Disc (registered trademark), a compact disc read-only memory (CD-ROM), a CD-recordable (R)/rewritable (RW), and the like.

A memory device and a memory reader/writer may be coupled to the input/output interface 102. The memory device is a recording medium having the function of communicating with the input/output interface 102. The memory reader/writer is a device that writes data to a memory card or reads data from the memory card. The memory card is a card-type recording medium.

The network interface 104 has the function of the WAN control unit 22, is coupled to a network, and performs network interface control. For example, a network interface card (NIC), a wireless local area network (LAN) card, or the like may be used as the network interface 104. Data received by the network interface 104 is output to the memory 101 or the processor 100.

The hardware configuration as described above may realize the processing function of the relay device 20. For example, the relay device 20 may perform processing of the embodiments by causing the processor 100 to execute a predetermined program.

The relay device 20 realizes the processing function of the embodiments by, for example, executing a program recorded in a computer-readable recording medium. The program in which content of processing to be executed by the relay device 20 is written may be recorded in various recording media.

For example, the program to be executed by the relay device 20 may be stored in the auxiliary storage device. The processor 100 loads at least part of the program in the auxiliary storage device into the main storage device and executes the program.

The program may be recorded in a portable recording medium such as an optical disk, a memory device, or a memory card. The program stored in the portable recording medium may be executed, for example, under the control of the processor 100 after being installed in the auxiliary storage device. The processor 100 may read the program directly from the portable recording medium and execute the program. Hardware similar to the above-described relay device 20 may be applied to the host devices #0 and #1.

### Path Connect Control

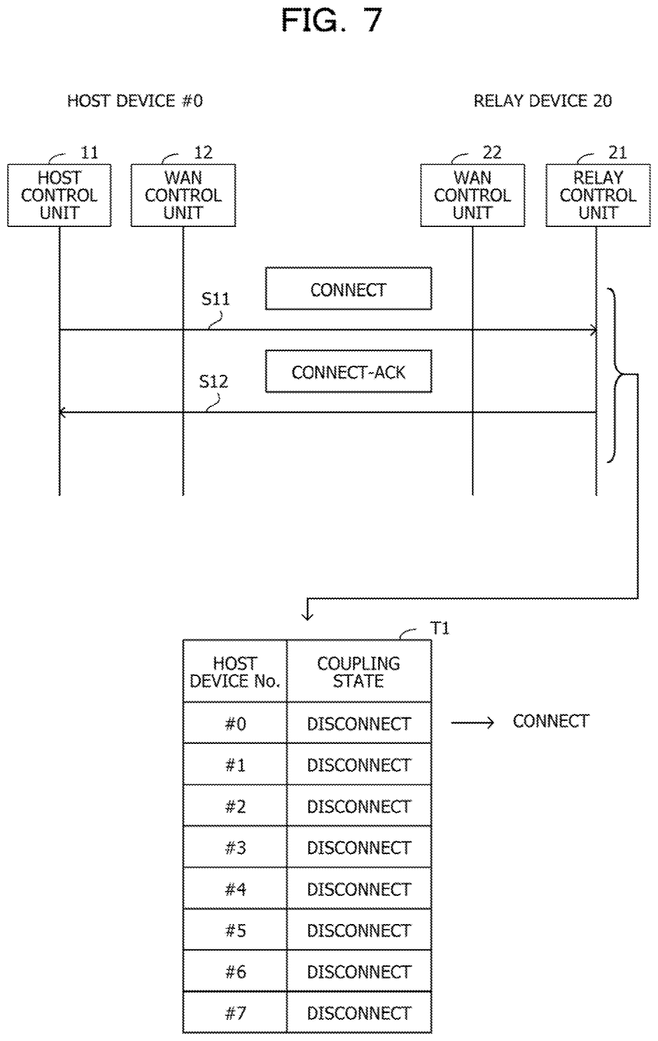

Next, the path connect control will be described with reference to FIGS. 7 to 13. FIG. 7 is a diagram illustrating an example of a basic sequence of the path connect control.

[Operation S11] The host control unit 11 in the host device #0 generates a CONNECT command (coupling request command) and transmits the CONNECT command to the relay device 20 via the WAN control unit 12.

[Operation S12] Upon receiving the CONNECT command, the relay control unit 21 in the relay device 20 generates a CONNECT-ACK response and transmits the CONNECT-ACK response to the host device #0 via the WAN control unit 22.

In the processing of the relay device 20, upon receiving the CONNECT command via the WAN control unit 22, the relay control unit 21 checks that there is no coupling with another host device at the time of receiving of the CONNECT command based on a management table T1.

The relay control unit 21 updates the coupling state with the host device #0 to CONNECT for the management table T1 and transmits the CONNECT-ACK response to the host device #0. The relay control unit 21 checks, via the WAN control unit 22, the delivery of the CONNECT-ACK response.

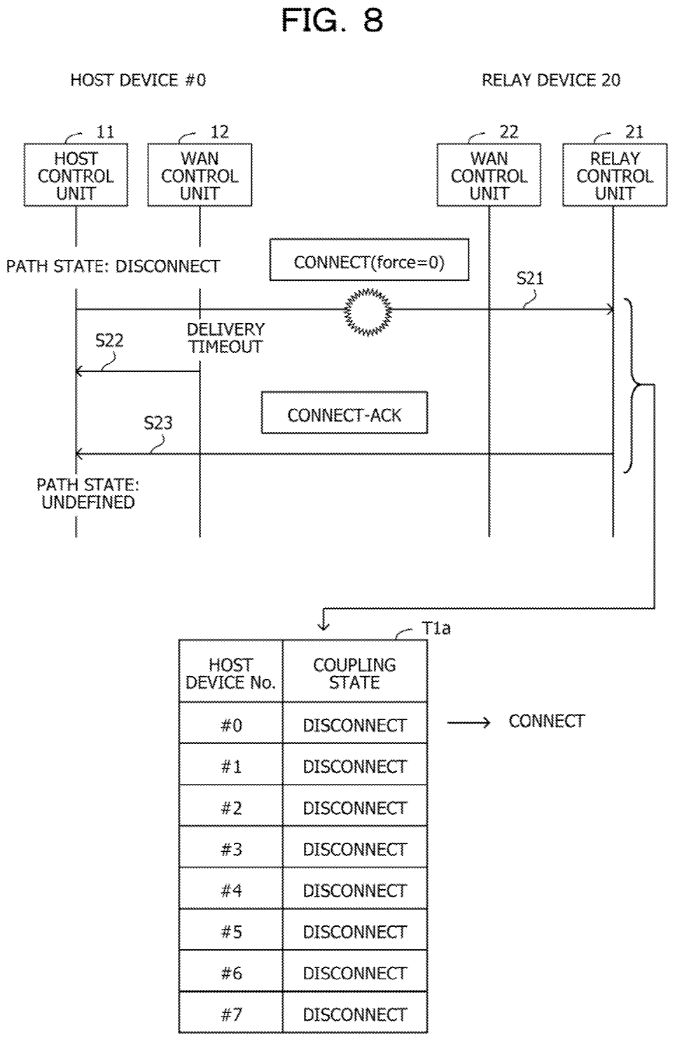

FIG. 8 is a diagram illustrating an example of a sequence of the path connect control. FIG. 8 illustrates a case where the CONNECT command from the host device #0 reaches the relay device 20 but a delivery timeout is generated on the host device #0 side.

[Operation S21] The host control unit 11 generates the CONNECT command and transmits the CONNECT command to the relay device 20 via the WAN control unit 12. A forced switching bit included in the CONNECT command is set to 0 (force=0). When the forced switching bit=0, the forced switching instruction is absent. Furthermore, it is assumed that an arrival of the CONNECT command at the relay device 20 is delayed compared to that in a normal operation due to, for example, a temporary high load of the network.

[Operation S22] In a case where the CONNECT-ACK response is not received within a predetermined period of time from the time when the host device #0 issues the command, the WAN control unit 12 detects the delivery timeout and notifies the host control unit 11 of the detection of the delivery timeout.

[Operation S23] After the detection of the delivery timeout, the host control unit 11 receives the CONNECT-ACK response transmitted from the relay device 20.

In the processing of the relay device 20, upon receiving the CONNECT command via the WAN control unit 22, the relay control unit 21 checks that there is no coupling with another host device at the time of receiving of the CONNECT command based on a management table T1a.

For the management table T1a, the relay control unit 21 updates the coupling state with the host device #0 to CONNECT. The relay control unit 21 transmits the CONNECT-ACK response to the host device #0. The relay control unit 21 checks, from the WAN control unit 22, the delivery of the CONNECT-ACK response.

Meanwhile, since the host control unit 11 receives the CON NECT-ACK response after the detection of the delivery timeout, the host control unit 11 determines that the path state is undefined. In a case where the host control unit 11 determines that the path state is undefined, for example, the host control unit 11 transmits to the upper software a status that the communication is unavailable so as to notify the operator.

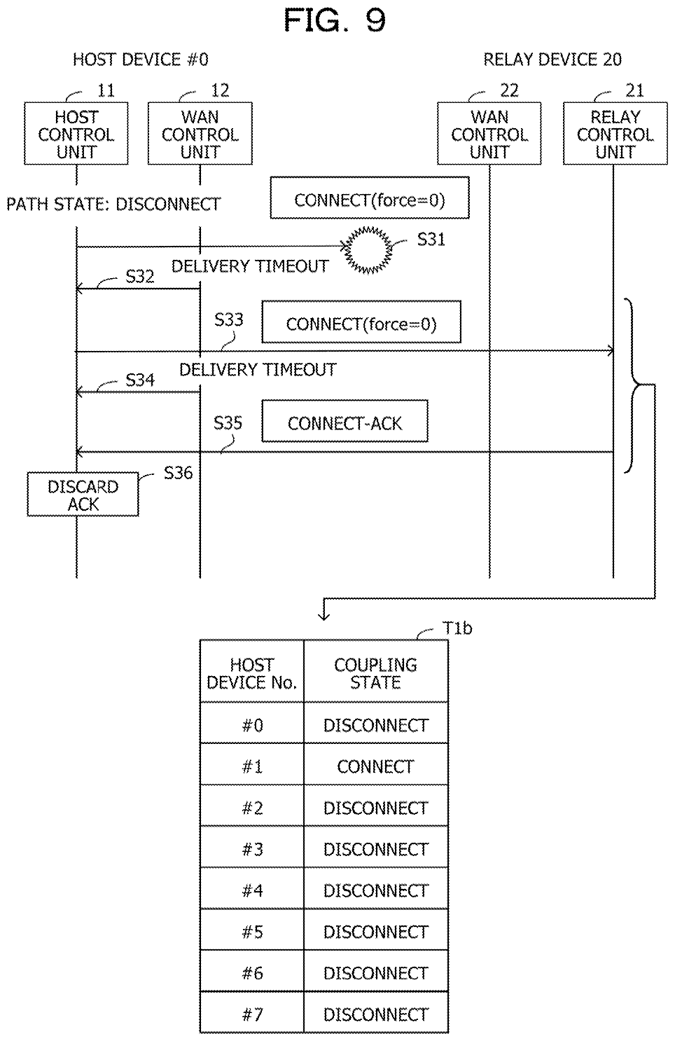

FIG. 9 is a diagram illustrating an example of a sequence of the path connect control. FIG. 9 illustrates a case where the CONNECT command from the host device #0 reaches the relay device 20 by using a TCP retransmission function but the delivery timeout is generated on the host device #0 side. It is assumed that the relay device 20 is in a state where the relay device 20 has already been coupled to the host device #1 different from the host device #0.

[Operation S31] The host control unit 11 generates the CONNECT command and transmits the CONNECT command to the relay device 20 via the WAN control unit 12. However, the CONNECT command does not reach the relay device 20 due to, for example, a temporary high load of the network. The forced switching bit included in the CONNECT command is set to 0 (force=0).

[Operation S32] In the case where the CONNECT-ACK response is not received within a predetermined period of time from the time when the host device #0 issues the command, the WAN control unit 12 detects the delivery timeout and notifies the host control unit 11 of the detection of the delivery timeout.

[Operation S33] The host control unit 11 retransmits, by using the TCP retransmission function, the CONNECT command via the WAN control unit 12, and the CONNECT command reaches the relay device 20. The forced switching bit included in the CONNECT command is set to 0 (force=0).

[Operation S34] It is assumed that the host control unit 11 detects the delivery timeout for the retransmitted CONNECT command.

[Operation S35] After the detection of the delivery timeout, the host control unit 11 receives the CONNECT-ACK response transmitted from the relay device 20.

[Operation S36] The host control unit 11 discards the CONNECT-ACK response received after the detection of the delivery timeout.

In the processing of the relay device 20, upon receiving the CONNECT command via the WAN control unit 22, the relay control unit 21 checks that there is coupling with the host device #1 at the time of receiving of the CONNECT command based on a management table T1b.

For the management table T1b, the relay control unit 21 maintains the coupling state with the host device #0 in DISCONNECT and does not change this state. A registration process in the management table T1b is performed by an upper layer. Based on the logic registered in the management table T1b in the upper layer, the relay control unit 21 outputs an instruction to a lower layer. In this case, the instruction is to maintain the coupling state with the host device #0 in DISCONNECT and not to change this state. The relay control unit 21 transmits the CONNECT-ACK response to the host device #0. The relay control unit 21 checks, from the WAN control unit 22, the delivery of the CONNECT-ACK response.

As described above, in the relay device 20, in the case where the coupling state with the host device #1 is the CONNECT state and the CONNECT command in which the forced switching bit is 0 is received from the host device #0, the coupling state with the host device #0 is maintained in DISCONNECT.

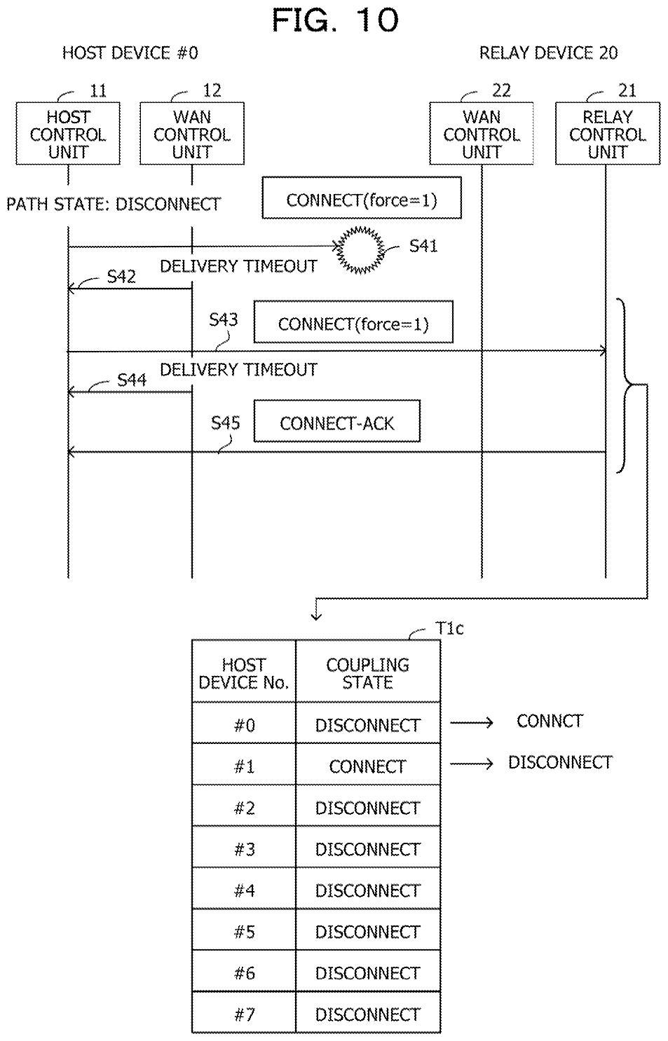

FIG. 10 is a diagram illustrating an example of a sequence of the path connect control. FIG. 10 illustrates the case where the CONNECT command from the host device #0 reaches the relay device 20 by using a TCP retransmission function but the delivery timeout is generated on the host device #0 side. It is assumed that the relay device 20 is in the state where the relay device 20 has already been coupled to the host device #1 different from the host device #0.

[Operation S41] The host control unit 11 generates the CONNECT command and transmits the CONNECT command to the relay device 20 via the WAN control unit 12. However, the CONNECT command does not reach the relay device 20 due to, for example, a temporary high load of the network. The forced switching bit included in the CONNECT command is set to 1 (force=1). When the forced switching bit=1, the forced switching instruction is present.

[Operation S42] In the case where the CONNECT-ACK response is not received within a predetermined period of time from the time when the host device #0 issues the command, the WAN control unit 12 detects the delivery timeout and notifies the host control unit 11 of the detection of the delivery timeout.

[Operation S43] The host control unit 11 retransmits, by using the TCP retransmission function, the CONNECT command via the WAN control unit 12, and the CONNECT command reaches the relay device 20. The forced switching bit included in the CONNECT command is set to 1 (force=1).

[Operation S44] It is assumed that the host control unit 11 detects the delivery timeout for the retransmitted CONNECT command.

[Operation S45] After the detection of the delivery timeout, the host control unit 11 receives the CONNECT-ACK response transmitted from the relay device 20.

In the processing of the relay device 20, upon receiving the CONNECT command via the WAN control unit 22, the relay control unit 21 detects that the forced switching bit is 1. Accordingly, the coupling state with the host device #0 is changed from DISCONNECT to CONNECT for a management table T1c. Since coupling with the host device #1 exists, the coupling state with the host device #1 is changed from CONNECT to DISCONNECT for the management table T1c.

The registration process in the management table T1c is performed by the upper layer. Based on the logic registered in the management table T1c in the upper layer, the relay control unit 21 outputs instructions to the lower layer. In this case, the instructions are to change the coupling state with the host device #0 from DISCONNECT to CONNECT and change the coupling state with the host device #1 from CONNECT to DISCONNECT. The relay control unit 21 transmits the CONNECT-ACK response to the host device #0. The relay control unit 21 checks, from the WAN control unit 22, the delivery of the CONNECT-ACK response.

As described above, in the relay device 20, in the case where the coupling state with the host device #1 is the CONNECT state, upon receiving the CONNECT command in which the forced switching bit is 1 from the host device #0, the host device #1 is set to DISCONNECT and the coupling state with the host device #0 is changed to CONNECT.

With such control, the consistency of the logic of the path coupling the host device #0 and the IO device 30 via the relay device 20 may be ensured. Even when the communication interface protocol for coupling the relay device 20 and the IO device 30 to each other is the fiber channel communication protocol, the above-described IO exclusive mechanism may be realized.

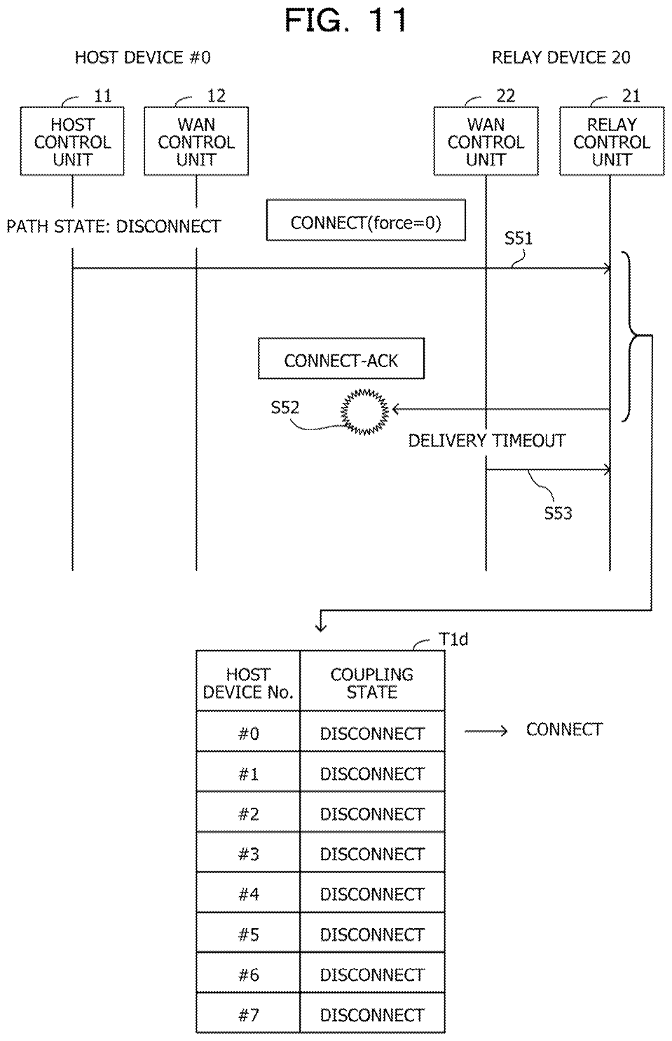

FIG. 11 is a diagram illustrating an example of a sequence of the path connect control. FIG. 11 illustrates a case where the CONNECT command from the host device #0 reaches the relay device 20 but the response does not reach the host device #0.

[Operation S51] The host control unit 11 generates the CONNECT command and transmits the CONNECT command to the relay device 20 via the WAN control unit 12. The forced switching bit included in the CONNECT command is set to 0 (force=0).

[Operation S52] The relay control unit 21 generates the CONNECT-ACK response and transmits the CONNECT-ACK response to the host device #0 via the WAN control unit 22. However, the CONNECT-ACK response does not reach the host device #0 due to, for example, a temporary high load of the network.

[Operation S53] In a case where a response from the host device #0 is not received within a predetermined period of time from the time when the relay control unit 21 issues the response, the WAN control unit 22 detects the delivery timeout and notifies the relay control unit 21 of the detection of the delivery timeout.

In the processing of the relay device 20, upon receiving the CONNECT command via the WAN control unit 22, the relay control unit 21 checks that there is no coupling with another host device at the time of receiving of the CONNECT command.

For a management table T1d, the relay control unit 21 updates the coupling state with the host device #0 to CONNECT. The relay control unit 21 transmits the CONNECT-ACK response to the host device #0. The relay control unit 21 checks, from the WAN control unit 22, the delivery timeout of the CONNECT-ACK response.

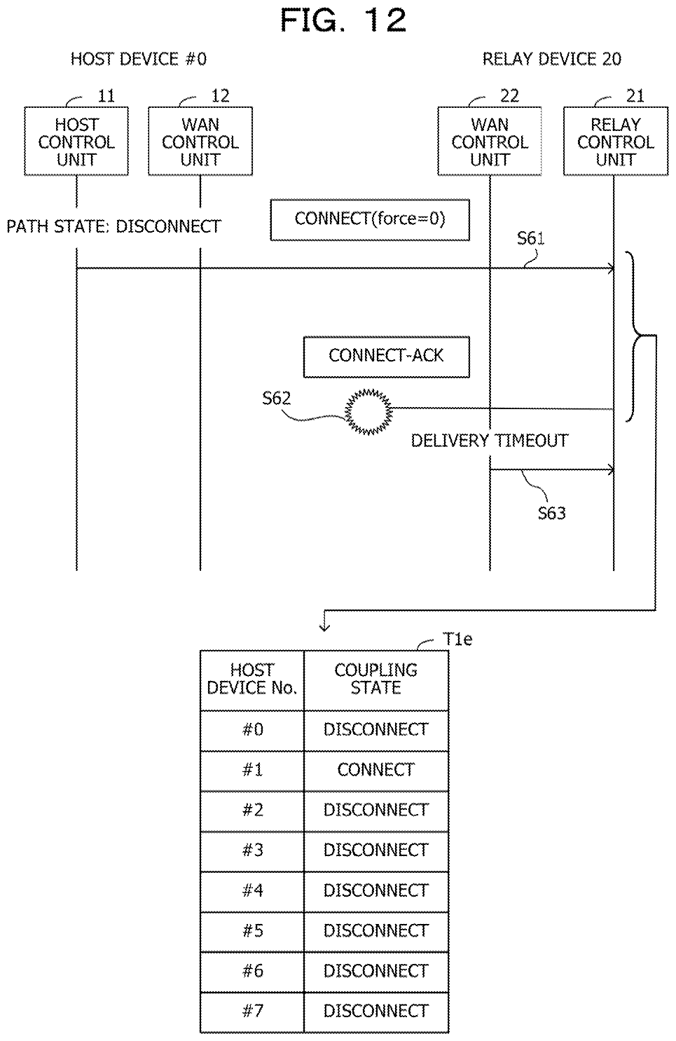

FIG. 12 is a diagram illustrating an example of a sequence of the path connect control. FIG. 12 illustrates a case where the CONNECT command from the host device #0 reaches the relay device 20 but the response does not reach the host device #0. It is assumed that the relay device 20 is in the state where the relay device 20 has already been coupled to the host device #1 different from the host device #0.

[Operation S61] The host control unit 11 generates the CONNECT command and transmits the CONNECT command to the relay device 20 via the WAN control unit 12. The forced switching bit included in the CONNECT command is set to 0 (force=0).

[Operation S62] The relay control unit 21 generates the CONNECT-ACK response and transmits the CONNECT-ACK response to the host device #0 via the WAN control unit 22. However, the CONNECT-ACK response does not reach the host due to, for example, a temporary high load of the network.

[Operation S63] In the case where the response from the host is not received within a predetermined period of time from the time when the relay control unit 21 issues the response, the WAN control unit 22 detects the delivery timeout and notifies the relay control unit 21 of the detection of the delivery timeout.

In the processing of the relay device 20, upon receiving the CONNECT command via the WAN control unit 22, the relay control unit 21 checks that there is coupling with the host device #1 at the time of receiving of the CONNECT command based on a management table T1e.

For the management table T1e, the relay control unit 21 maintains the coupling state with the host device #0 in DISCONNECT and does not change this state. The relay control unit 21 transmits the CONNECT-ACK response to the host device #0.

As described above, in the relay device 20, in the case where the coupling state with the host device #1 is the CONNECT state and the CONNECT command in which the forced switching bit is 0 is received from the host device #0, the coupling state with the host device #0 is maintained in DISCONNECT.

Meanwhile, since the host control unit 11 does not receive the CONNECT-ACK response, the host control unit 11 determines that the path state is undefined. In the case where the host control unit 11 determines that the path state is undefined, the host control unit 11 transmits to the upper software a status that the communication is unavailable so as to notify the operator.

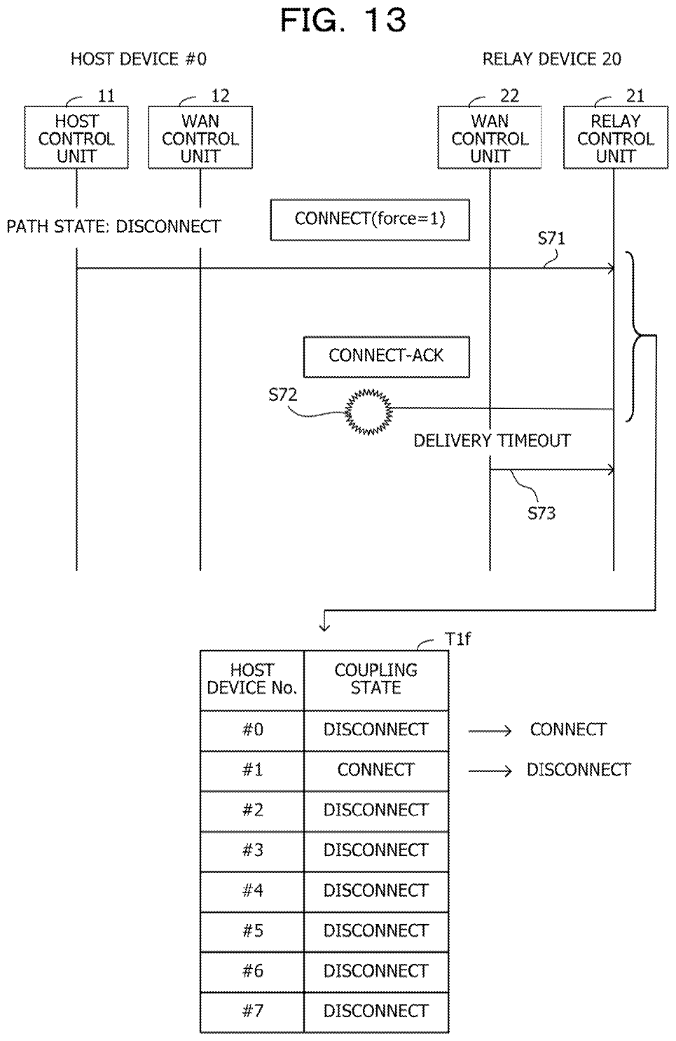

FIG. 13 is a diagram illustrating an example of a sequence of the path connect control. FIG. 13 illustrates the case where the CONNECT command from the host device #0 reaches the relay device 20 but the response does not reach the host device #0. It is assumed that the relay device 20 is in the state where the relay device 20 has already been coupled to the host device #1 different from the host device #0.

[Operation S71] The host control unit 11 generates the CONNECT command and transmits the CONNECT command to the relay device 20 via the WAN control unit 12. The forced switching bit included in the CONNECT command is set to 1 (force=1).

[Operation S72] The relay control unit 21 generates the CONNECT-ACK response and transmits the CONNECT-ACK response to the host device #0 via the WAN control unit 22. However, the CONNECT-ACK response does not reach the host due to, for example, a temporary high load of the network.

[Operation S73] In the case where the response from the host is not received within a predetermined period of time from the time when the relay control unit 21 issues the response, the WAN control unit 22 detects the delivery timeout and notifies the relay control unit 21 of the detection of the delivery timeout.

In the processing of the relay device 20, upon receiving the CONNECT command via the WAN control unit 22, the relay control unit 21 detects that the forced switching bit is 1. Accordingly, the coupling state with the host device #0 is changed from DISCONNECT to CONNECT for a management table T1f. Since coupling with the host device #1 exists, the coupling state with the host device #1 is changed from CONNECT to DISCONNECT for the management table T1f. The relay control unit 21 transmits the CONNECT-ACK response to the host device #0.

### Path Disconnect Control

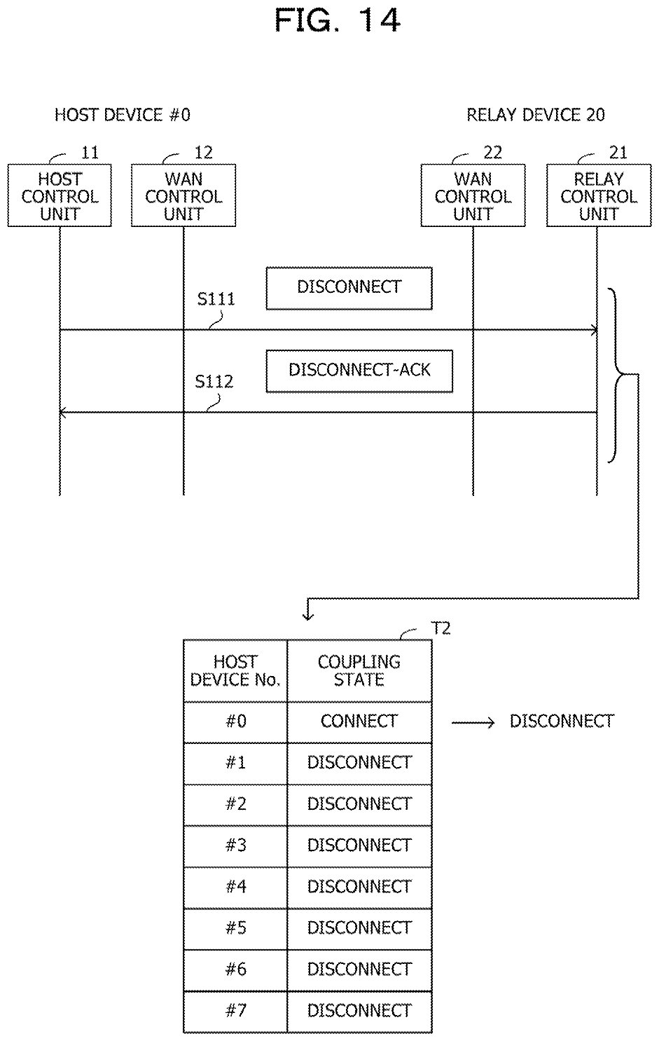

Next, the path disconnect control will be described with reference to FIGS. 14 to 20. FIG. 14 is a diagram illustrating an example of a basic sequence of the path disconnect control.

[Operation S111] The host control unit 11 in the host device #0 generates a DISCONNECT command and transmits the DISCONNECT command to the relay device 20 via the WAN control unit 12.

[Operation S112] Upon receiving the DISCONNECT command, the relay control unit 21 in the relay device 20 generates a DISCONNECT-ACK response and transmits the DISCONNECT-ACK response to the host device #0 via the WAN control unit 22.

In the processing of the relay device 20, upon receiving the DISCONNECT command via the WAN control unit 22, the relay control unit 21 updates the coupling state with the host device #0 from CONNECT to DISCONNECT for a management table T2. The relay control unit 21 transmits the DISCONNECT-ACK response to the host device #0. The relay control unit 21 checks, from the WAN control unit 22, the delivery of the DISCONNECT-ACK response.

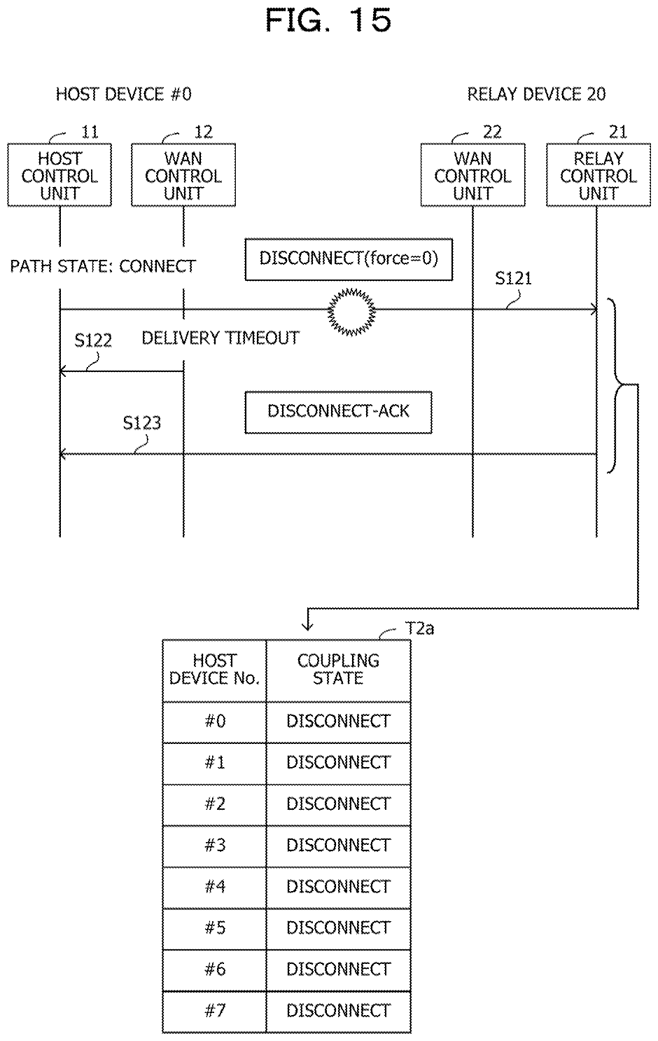

FIG. 15 is a diagram illustrating an example of a sequence of the path disconnect control. FIG. 15 illustrates a case where the DISCONNECT command from the host device #0 reaches the relay device 20 but the delivery timeout is generated on the host device #0 side.

[Operation S121] The host control unit 11 generates the DISCONNECT command and transmits the DISCONNECT command to the relay device 20 via the WAN control unit 12. The forced switching bit included in the DISCONNECT command is set to 0 (force=0). Furthermore, an arrival of the DISCONNECT command at the relay device 20 is delayed compared to that in a normal operation due to, for example, a temporary high load of the network.

[Operation S122] In a case where the DISCONNECT-ACK response is not received within a predetermined period of time from the time when the host device #0 issues the command, the WAN control unit 12 detects the delivery timeout and notifies the host control unit 11 of the detection of the delivery timeout.

[Operation S123] After the detection of the delivery timeout, the host control unit 11 receives the DISCONNECT-ACK response transmitted from the relay device 20.

In the processing of the relay device 20, upon receiving the DISCONNECT command via the WAN control unit 22, the relay control unit 21 checks that there is no coupling with another host device at the time of receiving of the DISCONNECT command based on a management table T2a.

For the management table T2a, the relay control unit 21 sets the coupling state with the host device #0 to DISCONNECT. The relay control unit 21 transmits the DISCONNECT-ACK response to the host device #0. The relay control unit 21 checks, from the WAN control unit 22, the delivery of the DISCONNECT-ACK response.

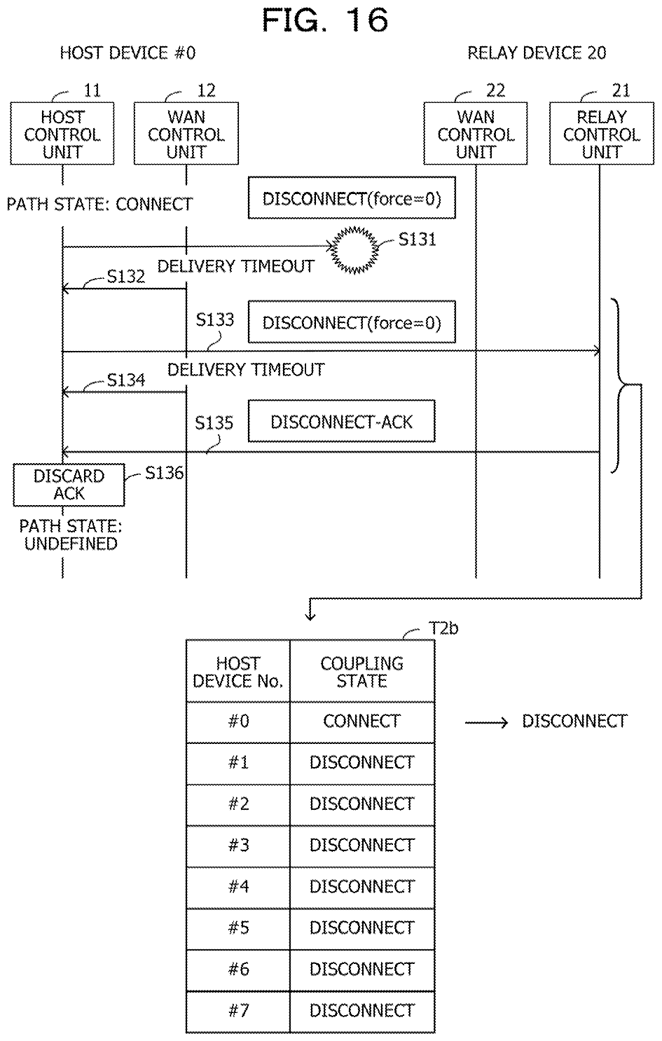

FIG. 16 is a diagram illustrating an example of a sequence of the path disconnect control. FIG. 16 illustrates a case where the DISCONNECT command from the host device #0 reaches the relay device 20 by using the TCP retransmission function but the delivery timeout is generated on the host device #0 side.

[Operation S131] The host control unit 11 generates the DISCONNECT command and transmits the DISCONNECT command to the relay device 20 via the WAN control unit 12. However, the DISCONNECT command does not reach the relay device 20 due to, for example, a temporary high load of the network. The forced switching bit included in the DISCONNECT command is set to 0 (force=0).

[Operation S132] In the case where the DISCONNECT-ACK response is not received within a predetermined period of time from the time when the host device #0 issues the command, the WAN control unit 12 detects the delivery timeout and notifies the host control unit 11 of the detection of the delivery timeout.

[Operation S133] The host control unit 11 retransmits, by using the TCP retransmission function, the DISCONNECT command via the WAN control unit 12, and the DISCONNECT command reaches the relay device 20. The forced switching bit included in the DISCONNECT command is set to 0 (force=0).

[Operation S134] The host control unit 11 detects the delivery timeout.

[Operation S135] After the detection of the delivery timeout, the host control unit 11 receives the DISCONNECT-ACK response transmitted from the relay device 20.

[Operation S136] The host control unit 11 discards the DISCONNECT-ACK response received after the detection of the delivery timeout.

In the processing of the relay device 20, upon receiving the DISCONNECT command via the WAN control unit 22, the relay control unit 21 changes the coupling state with the host device #0 from CONNECT to DISCONNECT for a management table T2b. The relay control unit 21 transmits the DISCONNECT-ACK response to the host device #0. The relay control unit 21 checks, from the WAN control unit 22, the delivery of the DISCONNECT-ACK response.

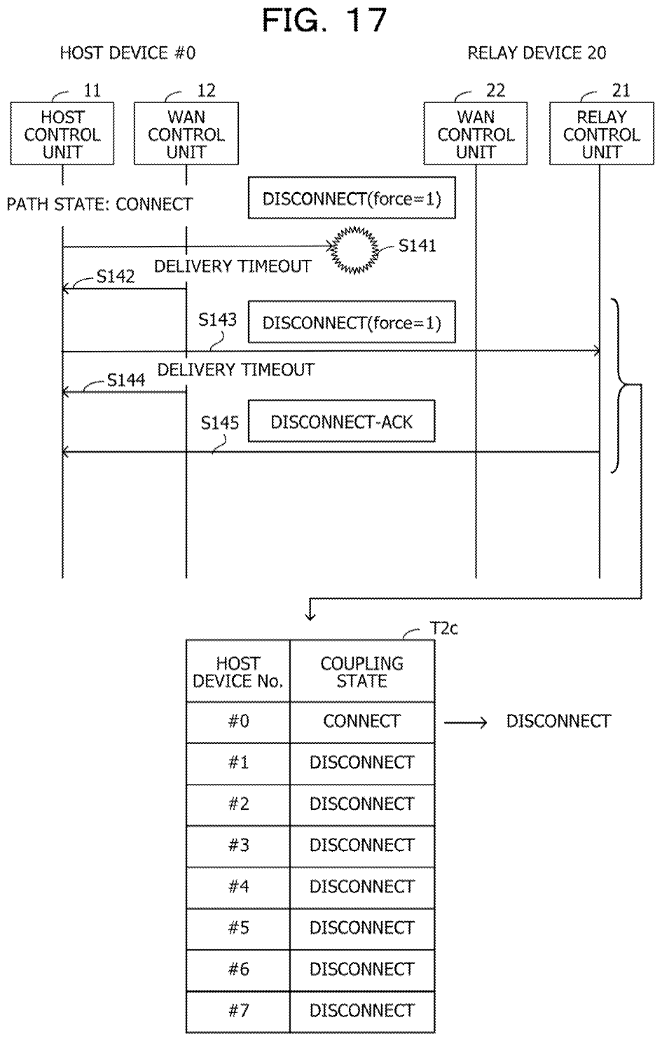

FIG. 17 is a diagram illustrating an example of a sequence of the path disconnect control. FIG. 17 illustrates the case where the DISCONNECT command from the host device #0 reaches the relay device 20 by using the TCP retransmission function but the delivery timeout is generated on the host device #0 side.

[Operation S141] The host control unit 11 generates the DISCONNECT command and transmits the DISCONNECT command to the relay device 20 via the WAN control unit 12. However, the DISCONNECT command does not reach the relay device 20 due to, for example, a temporary high load of the network. The forced switching bit included in the DISCONNECT command is set to 1 (force=1).

[Operation S142] In the case where the DISCONNECT-ACK response is not received within a predetermined period of time from the time when the host device #0 issues the command, the WAN control unit 12 detects the delivery timeout and notifies the host control unit 11 of the detection of the delivery timeout.

[Operation S143] The host control unit 11 retransmits, by using the TCP retransmission function, the DISCONNECT command via the WAN control unit 12, and the DISCONNECT command reaches the relay device 20. The forced switching bit included in the DISCONNECT command is set to 1 (force=1).

[Operation S144] The host control unit 11 detects the delivery timeout.

[Operation S145] After the detection of the delivery timeout, the host control unit 11 receives the DISCONNECT-ACK response transmitted from the relay device 20.

In the processing of the relay device 20, upon receiving the DISCONNECT command via the WAN control unit 22, the relay control unit 21 detects that the forced switching bit is 1. Accordingly, the coupling state with the host device #0 is changed from CONNECT to DISCONNECT for a management table T2c. The relay control unit 21 transmits the DISCONNECT-ACK response to the host device #0. The relay control unit 21 checks, from the WAN control unit 22, the delivery of the DISCONNECT-ACK response.

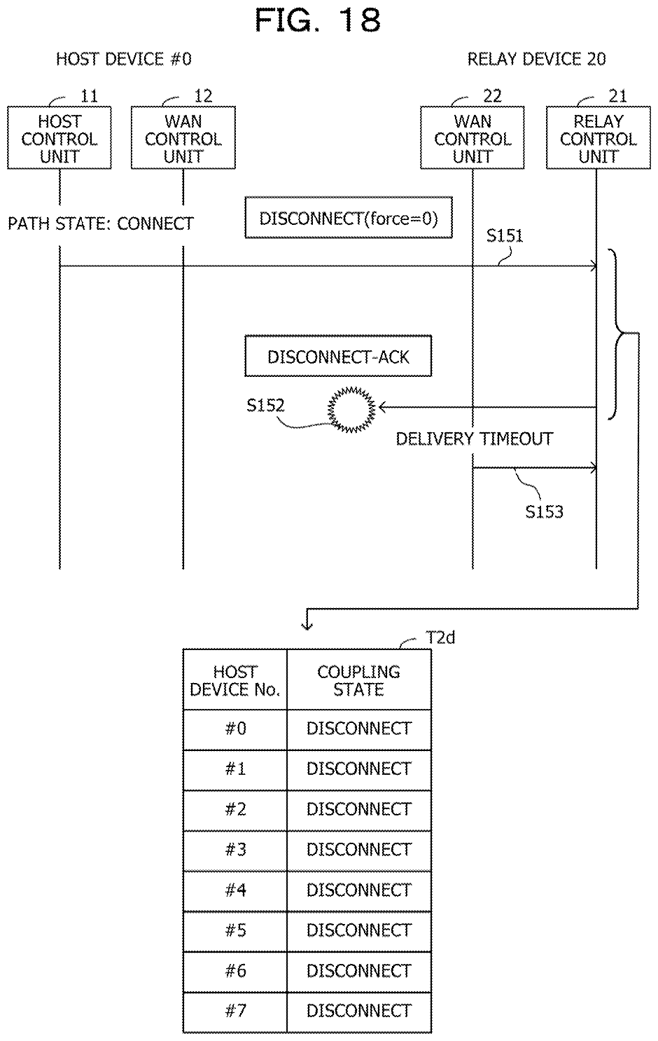

FIG. 18 is a diagram illustrating an example of a sequence of the path disconnect control. FIG. 18 illustrates a case where the DISCONNECT command from the host device #0 reaches the relay device 20 but the response does not reach the host device.

[Operation S151] The host control unit 11 generates the DISCONNECT command and transmits the DISCONNECT command to the relay device 20 via the WAN control unit 12. The forced switching bit included in the DISCONNECT command is set to 0 (force=0).

[Operation S152] The relay control unit 21 generates the DISCONNECT-ACK response and transmits the DISCONNECT-ACK response to the host device #0 via the WAN control unit 22. However, the DISCONNECT-ACK response does not reach the host due to, for example, a temporary high load of the network.

[Operation S153] In the case where the response from the host is not received within a predetermined period of time from the time when the relay device 20 issues the response, the WAN control unit 22 detects the delivery timeout and notifies the relay control unit 21 of the detection of the delivery timeout.

In the processing of the relay device 20, upon receiving the DISCONNECT command via the WAN control unit 22, the relay control unit 21 sets the coupling state with the host device #0 to DISCONNECT for a management table T2d. The relay control unit 21 transmits the DISCONNECT-ACK response to the host device #0. The relay control unit 21 checks, from the WAN control unit 22, the delivery timeout of the DISCONNECT-ACK response.

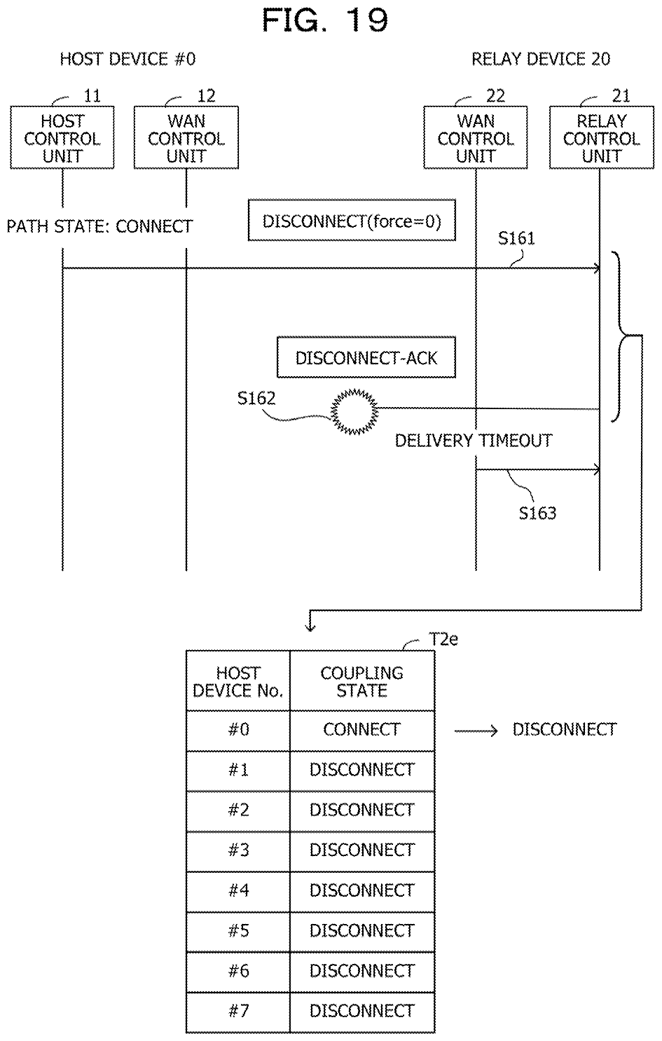

FIG. 19 is a diagram illustrating an example of a sequence of the path disconnect control. FIG. 19 illustrates the case where the DISCONNECT command from the host device #0 reaches the relay device 20 but the response does not reach the host device.

[Operation S161] The host control unit 11 generates the DISCONNECT command and transmits the DISCONNECT command to the relay device 20 via the WAN control unit 12. The forced switching bit included in the DISCONNECT command is set to 0 (force=0).

[Operation S162] The relay control unit 21 generates the DISCONNECT-ACK response and transmits the DISCONNECT-ACK response to the host device #0 via the WAN control unit 22. However, the DISCONNECT-ACK response does not reach the host due to, for example, a temporary high load of the network.

[Operation S163] In the case where the response from the host is not received within a predetermined period of time from the time when the relay device 20 issues the response, the WAN control unit 22 detects the delivery timeout and notifies the relay control unit 21 of the detection of the delivery timeout.

In the processing of the relay device 20, upon receiving the DISCONNECT command via the WAN control unit 22, the relay control unit 21 changes the coupling state with the host device #0 from CONNECT to DISCONNECT for a management table T2e. The relay control unit 21 transmits the DISCONNECT-ACK response to the host device #0. The relay control unit 21 checks, from the WAN control unit 22, the delivery of the DISCONNECT-ACK response.

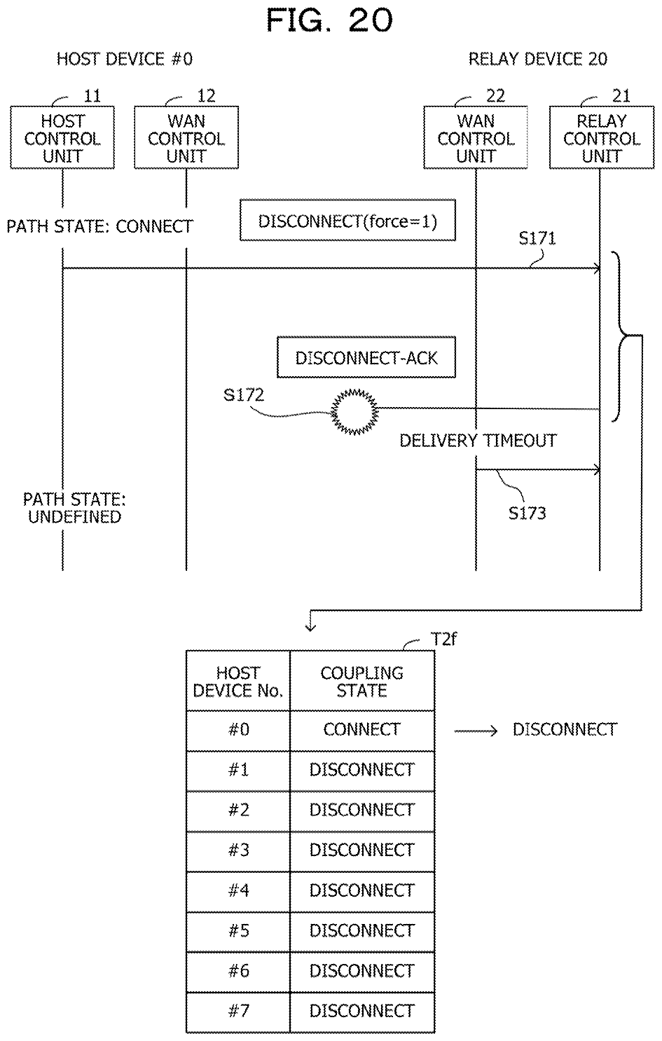

FIG. 20 is a diagram illustrating an example of a sequence of the path disconnect control. FIG. 20 illustrates the case where the DISCONNECT command from the host device #0 reaches the relay device 20 but the response does not reach the host device #0.

[Operation S171] The host control unit 11 generates the DISCONNECT command and transmits the DISCONNECT command to the relay device 20 via the WAN control unit 12. The forced switching bit included in the DISCONNECT command is set to 1 (force=1).

[Operation S172] The relay control unit 21 generates the DISCONNECT-ACK response and transmits the DISCONNECT-ACK response to the host device #0 via the WAN control unit 22. However, the DISCONNECT-ACK response does not reach the host due to, for example, a temporary high load of the network.

[Operation S173] In the case where the response from the host is not received within a predetermined period of time from the time when the relay device 20 issues the response, the WAN control unit 22 detects the delivery timeout and notifies the relay control unit 21 of the detection of the delivery timeout.

In the processing of the relay device 20, upon receiving the DISCONNECT command via the WAN control unit 22, the relay control unit 21 detects that the forced switching bit is 1. Accordingly, the coupling state with the host device #0 is changed from CONNECT to DISCONNECT for a management table T2f. The relay control unit 21 transmits the DISCONNECT-ACK response to the host device #0. The relay control unit 21 checks, from the WAN control unit 22, the delivery of the DISCONNECT-ACK response.

Meanwhile, since the host control unit 11 does not receive the DISCONNECT-ACK response, the host control unit 11 determines that the path state is undefined. In the case where the host control unit 11 determines that the path state is undefined, the host control unit 11 transmits to the upper software a status that the communication is unavailable so as to notify the operator.

### Path Switching Control

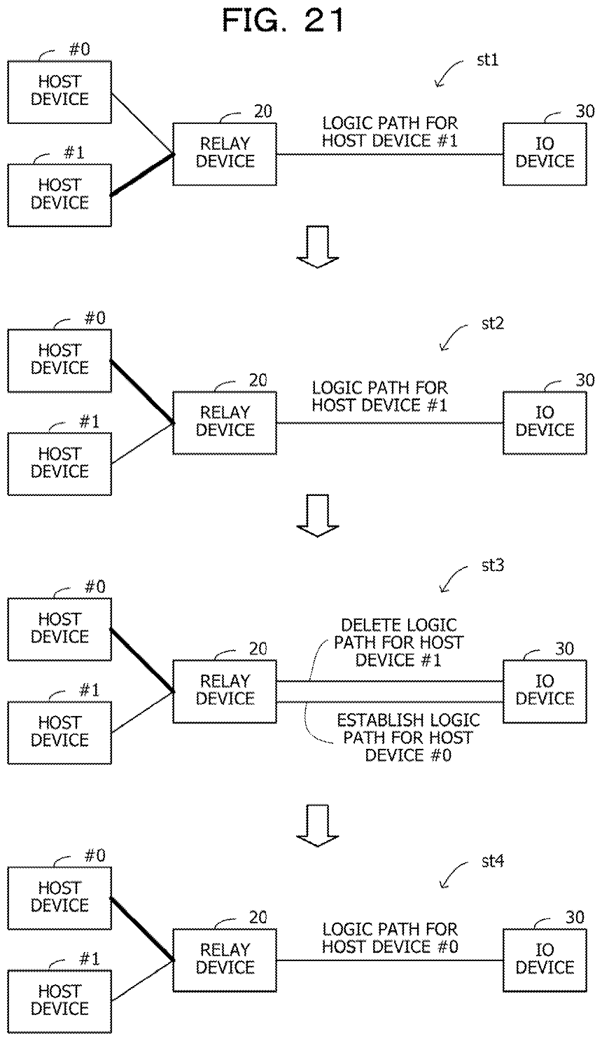

FIG. 21 is a diagram for explaining an example of a path switching control.

[State st1] A state before the switching of the host device is illustrated. The host device #1 is coupled to the IO device 30 subordinate to the relay device 20 via the relay device 20. A logic path for the host device #1 couples the relay device 20 and the IO device 30 to each other.

[State st2] Path switching from the host device #1 to the host device #0 is generated.

[State st3] Upon recognizing a path switching request from the host device #1 to the host device #0, the relay device 20 deletes the logic path for the host device #1 between the relay device 20 and the IO device 30 and establishes a logic path for the host device #0.

[State st4] The host device #0 is coupled to the IO device 30 subordinate to the relay device 20 via the relay device 20. The logic path for the host device #0 couples the relay device 20 and the IO device 30 to each other.

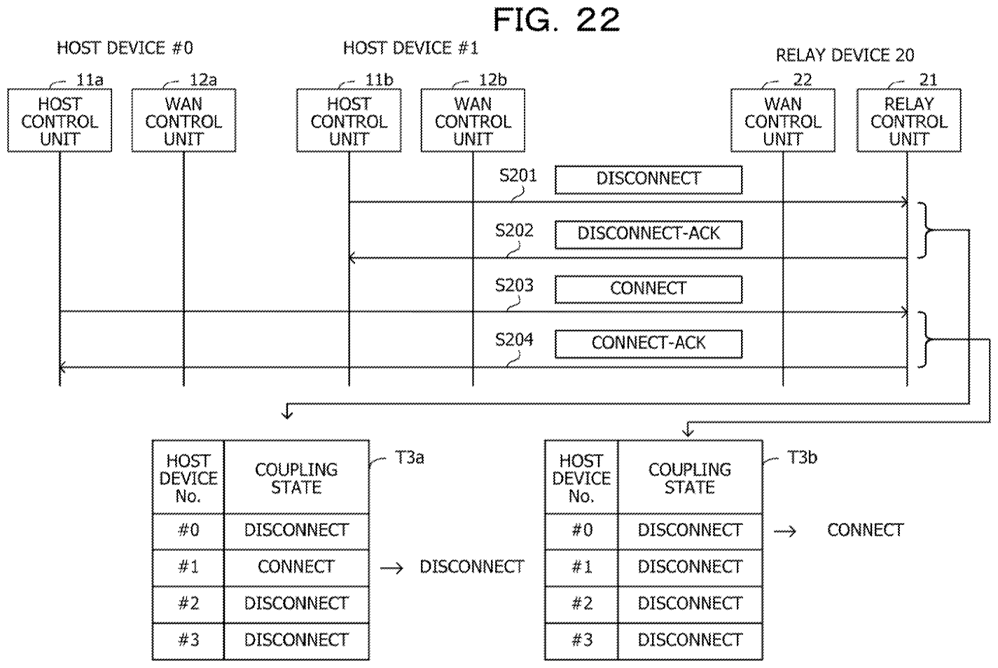

FIG. 22 is a diagram illustrating an example of a sequence of the path switching control.

[Operation S201] A host control unit 11b in the host device #1 generates the DISCONNECT command and transmits the DISCONNECT command to the relay device 20 via a WAN control unit 12b.

Here, an operator of the host device #1 executes the decoupling request command to decouple ownership rights of the IO device 30 subordinate to the relay device 20 and the host device #1. Thus, the DISCONNECT command is executed from the host control unit 11b to cancel the path between the host device #1 and the relay device 20.

[Operation S202] Upon receiving the DISCONNECT command, the relay control unit 21 in the relay device 20 changes the coupling state with the host device #1 from CONNECT to DISCONNECT for a management table T3a. The relay control unit 21 generates the DISCONNECT-ACK response and transmits the DISCONNECT-ACK response to the host device #1 via the WAN control unit 22. Thus, a logical path between the host device #1 and the relay device 20 is canceled.

[Operation S203] A host control unit 11a in the host device #0 generates the CONNECT command and transmits the CONNECT command to the relay device 20 via a WAN control unit 12a.

Here, an operator of the host device #0 executes the coupling request command of the path to obtain ownership rights of the IO device 30 subordinate to the relay device 20 and the host device #0. Thus, the CONNECT command is executed from the host control unit 11a to couple the path between the host device #0 and the relay device 20.

[Operation S204] Upon receiving the CONNECT command, the relay control unit 21 in the relay device 20 changes the coupling state with the host device #0 from DISCONNECT to CONNECT for a management table T3b. The relay control unit 21 generates the CONNECT-ACK response and transmits the CONNECT-ACK response to the host device #0 via the WAN control unit 22. Thus, a logical path between the host device #0 and the relay device 20 is coupled. After that, the host device #0 occupies the IO device 30 subordinate to the relay device 20.

### Interface Correlation between Host Device and Relay Device

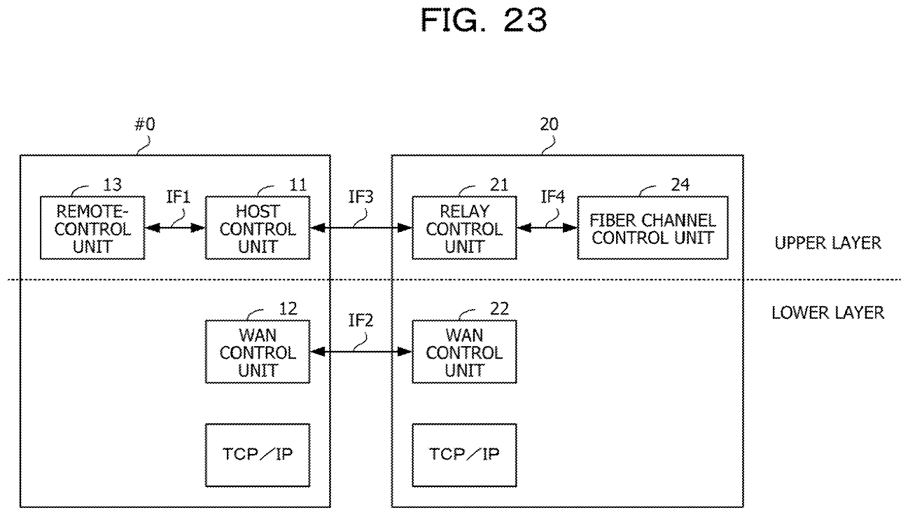

FIG. 23 is a diagram illustrating an example of an interface correlation between the host device and the relay device. The host device #0 includes the host control unit 11, the WAN control unit 12, and a remote-control unit 13. The relay device 20 includes the relay control unit 21, the WAN control unit 22, and a fiber channel control unit 24. The fiber channel control unit 24 includes a fiber channel specific processing function, a driver function, and so forth. The WAN control units 12 and 22 are located in a lower layer (first layer). The host control unit 11, the relay control unit 21, the remote-control unit 13, and the fiber channel control unit 24 are located in an upper layer (second layer).

As an open systems interconnection (OSI) hierarchy, the lower layer includes, for example, a physical layer, a data link layer, a network layer, and a transport layer. The upper layer includes, for example, a session layer, a presentation layer, and an application layer.

[Interface IF1] For example, creation of operational data, management and control of a communication sequence, flow amount control, and response check timer drive control are performed between the remote-control unit 13 and the host control unit 11. The remote-control unit 13 receives and transfers data by using an inter-component public function provided to the fiber channel control unit 24 as a common interface.

[Interface IF2] For example, management of an operational TCP session, compression and decompression of the operational data, and transmission and reception of the operational data are performed between the WAN control unit 12 and the WAN control unit 22. Communication via Interface IF2 is performed by using a TCP/IP communication socket of Linux (registered trademark) between the WAN control units 12 and 22.

[Interface IF3] The creation of the operational data, the management and control of the communication sequence, and the response check timer drive control are performed between the host control unit 11 and the relay control unit 21. The operational data distributed between the host device #0 and the relay device 20 is used for Interface IF3.

[Interface IF4] Instructions for ending/starting of the processing, the creation of the operational data, the management and control of the communication sequence, and the response check timer drive control are performed between the relay control unit 21 and the fiber channel control unit 24. The application programming interface (API) of Linux and data of the public function provided by the remote-control unit 13 are received and transferred via the interface IF4.

The processing functions of the communication system and the relay device according to the above-described present disclosure may be realized by a computer. In this case, there is provided a program in which processing content of functions to be included in the communication system and the relay device is described. By executing the program on the computer, the processing functions described above is realized in the computer.

The program in which the processing content is described may be recorded in a computer-readable recording medium. Examples of the computer-readable recording medium include a magnetic storage unit, an optical disk, a magneto-optical recording medium, a semiconductor memory, and the like. Examples of the magnetic storage unit include an HDD, a flexible disk (FD), a magnetic tape, and the like. Examples of the optical disk include a CD-ROM/RW and the like. Examples of the magneto-optical recording medium include a magneto-optical (MO) disk and the like.

In a case where the program is to be distributed, for example, a portable recording medium such as a CD-ROM in which the program is recorded is sold. The program may be stored in a storage unit of a server computer and transferred from the server computer to another computer via a network.

For example, the computer executing the program stores, in its storage unit, the program recorded in the portable recording medium or the program transferred from the server computer. The computer reads the program from its storage unit and executes the processing in accordance with the program. The computer may read the program directly from the portable recording medium and execute the processing in accordance with the program.

Every time the program is transferred from the server computer coupled via the network to the computer, the computer may sequentially execute processing in accordance with the received program. At least part of the above-described processing function may be realized by using an electronic circuit such as a DSP, an ASIC, and a PLD.

Hereinabove, the examples of the embodiments have been described. However, the configuration of each unit illustrated in the embodiments may be replaced with another unit having the same or similar function. Arbitrary other elements and processes may be added. Two or more arbitrary configurations (features) out of the above-described embodiments may be combined together.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication system comprising:
a first communication device;
a second communication device;
a third communication device; and
a relay device comprising:
a memory; and
a processor coupled to the memory and configured to,
in a state where a first path through which the second communication device is coupled to the third communication device is established, when a coupling request command for establishing a second path through which the first communication device is coupled to the third communication device is received from the first communication device, establish the second path and cancel the first path in a case where the coupling request command that includes a forced switching instruction is detected.

2. The communication system according to claim 1, wherein,
in the state where the first path is established between the second communication device and the third communication device, the processor maintains establishment of the first path without establishing the second path in a case where the coupling request command that does not include the forced switching instruction is detected.

3. The communication system according to claim 1, wherein,
in a state where the first path through which the second communication device is coupled to the third communication device is established in a first layer, when the processor receives, from the first communication device, the coupling request command for establishing the second path through which the first communication device is coupled to the third communication device in the first layer, the processor
sets a first logic for which the first communication device is coupled to the third communication device and a second logic for canceling that the second communication device is coupled to the third communication device, in a second layer that is a layer upper than the first layer, in the case where the coupling request command that includes the forced switching instruction is detected, and
establishes the second path based on the first logic and cancels the first path based on the second logic to perform path switching in the first layer based on the first logic and the second logic in the second layer.

4. The communication system according to claim 3, wherein,
in the state where the first path is established between the second communication device and the third communication device, in a case the coupling request command that does not include the forced switching instruction is detected, the processor
sets a third logic for which the first communication device is decoupled from the third communication device and a fourth logic for which the second communication device is coupled to the third communication device in the second layer,
does not establish the second path based on the third logic, and
maintains establishment of the first path based on the fourth logic.

5. The communication system according to claim 1, wherein,
in a state where the first path is not established between the second communication device and the third communication device, the processor establishes the second path in a case where the coupling request command that does not include the forced switching instruction is detected.

6. The communication system according to claim 1, wherein
the relay device is coupled to the third communication device by using a fiber channel communication protocol.

7. The communication system according to claim 1, wherein
the processor is operated by a virtual operating system transmitted from the first communication device or the second communication device when path switching is executed.

8. A relay device comprising:
an interface circuit configured to communicate a first communication device and a second communication device;
a memory; and
a processor coupled to the memory and configured to,
in a state where a first path through which the second communication device is coupled to a third communication device is established, when a coupling request command for establishing a second path through which the first communication device is coupled to the third communication device is received from the first communication device, establish the second path and cancel the first path in a case where the coupling request command that includes a forced switching instruction is detected.

9. A method of communicating of a relay device coupled to a first communication device, a second communication device, and a third communication device, the method comprising:
in a state where a first path through which the second communication device is coupled to a third communication device is established, when a coupling request command for establishing a second path through which the first communication device is coupled to the third communication device is received from the first communication device, establishing the second path and canceling the first path in a case where the coupling request command that includes a forced switching instruction is detected.
